(19) United States
(12) Patent Application Publication
(10) Pub. No.: US 2006/0127858 A1
(43) Pub. Date: Jun. 15, 2006

(54) Producing accurate base for a dental arch model

(76) Inventor: Huafeng Wen, Redwood City, CA (US)

Correspondence Address: MORRISON & FOERSTER LLP, 755 PAGE MILL RD, PALO ALTO, CA, 94304-1018, US

(21) Appl. No.: 11/013,157

(22) Filed: Dec. 14, 2004

(51) Int. Cl. A61C 11/00; A61C 19/00

(52) U.S. Cl. 433/213; 433/74

(57) ABSTRACT

Systems and methods are disclosed for producing a base configured to receive physical tooth models includes acquiring the coordinates of the physical tooth models in the physical dental arch model using an optical location device. The method determines the configurations of first features affixed to the physical tooth models. The locations of second features in the base are determined in accordance with the coordinates of the physical tooth models in the physical dental arch model and the configurations of the first features, wherein the second features are configured to receive the first features affixed to the physical tooth models.

### CROSS-REFERENCES TO RELATED INVENTIONS

The present invention is related to concurrently filed and commonly assigned U.S. patent application, titled “A base for physical dental arch model” by Huafeng Wen, concurrently filed and commonly assigned U.S. patent application, titled “Accurately producing a base for physical dental arch model” by Huafeng Wen, concurrently filed and commonly assigned U.S. patent application, titled “Fabricating a base compatible with physical dental tooth models” by Huafeng Wen, concurrently filed and commonly assigned U.S. patent application, titled “Producing non-interfering tooth models on a base” by Huafeng Wen, concurrently filed and commonly assigned U.S. patent application, titled “System and methods for casting physical tooth model” by Huafeng Wen, and concurrently filed and commonly assigned U.S. patent application, titled “Producing a base for accurately receiving dental tooth models” by Huafeng Wen.

The present invention is also related to U.S. patent application, titled “Method and apparatus for manufacturing and constructing a physical dental arch model” by Huafeng Wen, Nov. 1, 2004, U.S. patent application, titled “Method and apparatus for manufacturing and constructing a dental aligner” by Huafeng Wen, Nov. 1, 2004, U.S. patent application, titled “Producing an adjustable physical dental arch model” by Huafeng Wen, Nov. 1, 2004, and U.S. patent application, titled “Producing a base for physical dental arch model” by Huafeng Wen, Nov. 1, 2004. The disclosure of these related applications are incorporated herein by reference.

### TECHNICAL FIELD

This application generally relates to the field of dental care, and more particularly to a system and a method for manufacturing and constructing a physical dental arch model.

### BACKGROUND

Orthodontics is the practice of manipulating a patient's teeth to provide better function and appearance. In general, brackets are bonded to a patient's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a patient may be fitted with a retainer.

To achieve tooth movement, orthodontists utilize their expertise to first determine a three-dimensional mental image of the patient's physical orthodontic structure and a three-dimensional mental image of a desired physical orthodontic structure for the patient, which may be assisted through the use of x-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, the next step in the treatment (e.g., new bend in the wire, reposition or replace brackets, is head gear required, etc.), and the success of the previous step.

In general, the orthodontist makes manual adjustments to the wire and/or replaces or repositions brackets based on his or her expert opinion. Unfortunately, in the oral environment, it is impossible for a human being to accurately develop a visual three-dimensional image of an orthodontic structure due to the limitations of human sight and the physical structure of a human mouth. In addition, it is humanly impossible to accurately estimate three-dimensional wire bends (with an accuracy within a few degrees) and to manually apply such bends to a wire. Further, it is humanly impossible to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the process success and speed being very much dependent on the orthodontist's motor skills and diagnostic expertise. As a result of multiple wire changes, patient discomfort is increased as well as the cost. As one would expect, the quality of care varies greatly from orthodontist to orthodontist as does the time to treat a patient.

As described, the practice of orthodontic is very much an art, relying on the expert opinions and judgments of the orthodontist. In an effort to shift the practice of orthodontic from an art to a science, many innovations have been developed. For example, U.S. Pat. No. 5,518,397 issued to Andreiko, et. al. provides a method of forming an orthodontic brace. Such a method includes obtaining a model of the teeth of a patient's mouth and a prescription of desired positioning of such teeth. The contour of the teeth of the patient's mouth is determined, from the model. Calculations of the contour and the desired positioning of the patient's teeth are then made to determine the geometry (e.g., grooves or slots) to be provided. Custom brackets including a special geometry are then created for receiving an arch wire to form an orthodontic brace system. Such geometry is intended to provide for the disposition of the arched wire on the bracket in a progressive curvature in a horizontal plane and a substantially linear configuration in a vertical plane. The geometry of the brackets is altered, (e.g., by cutting grooves into the brackets at individual positions and angles and with particular depth) in accordance with such calculations of the bracket geometry. In such a system, the brackets are customized to provide three-dimensional movement of the teeth, once the wire, which has a two dimensional shape (i.e., linear shape in the vertical plane and curvature in the horizontal plane), is applied to the brackets.

Other innovations relating to bracket and bracket placements have also been patented. For example, such patent innovations are disclosed in U.S. Pat. No. 5,618,716 entitled “Orthodontic Bracket and Ligature” a method of ligating arch wires to brackets, U.S. Pat. No. 5,011,405 “Entitled Method for Determining Orthodontic Bracket Placement,” U.S. Pat. No. 5,395,238 entitled “Method of Forming Orthodontic Brace,” and U.S. Pat. No. 5,533,895 entitled “Orthodontic Appliance and Group Standardize Brackets therefore and methods of making, assembling and using appliance to straighten teeth”.

Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the arch is described in U.S. Pat. Nos. 5,342,202 and 5,340,309.

Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

The key to efficiency in treatment and maximum quality in results is a realistic simulation of the treatment process. Today's orthodontists have the possibility of taking plaster models of the upper and lower arch, cutting the model into single tooth models and sticking these tooth models into a wax bed, lining them up in the desired position, the so-called set-up. This approach allows for reaching a perfect occlusion without any guessing. The next step is to bond a bracket at every tooth model. This would tell the orthodontist the geometry of the wire to run through the bracket slots to receive exactly this result. The next step involves the transfer of the bracket position to the original malocclusion model. To make sure that the brackets will be bonded at exactly this position at the real patient's teeth, small templates for every tooth would have to be fabricated that fit over the bracket and a relevant part of the tooth and allow for reliable placement of the bracket on the patient's teeth. To increase efficiency of the bonding process, another option would be to place each single bracket onto a model of the malocclusion and then fabricate one single transfer tray per arch that covers all brackets and relevant portions of every tooth. Using such a transfer tray guarantees a very quick and yet precise bonding using indirect bonding.

U.S. Pat. No. 5,431,562 to Andreiko et al. describes a computerized, appliance-driven approach to orthodontics. In this method, first certain shape information of teeth is acquired. A uniplanar target arcform is calculated from the shape information. The shape of customized bracket slots, the bracket base, and the shape of the orthodontic archwire, are calculated in accordance with a mathematically-derived target archform. The goal of the Andreiko et al. method is to give more predictability, standardization, and certainty to orthodontics by replacing the human element in orthodontic appliance design with a deterministic, mathematical computation of a target archform and appliance design. Hence the '562 patent teaches away from an interactive, computer-based system in which the orthodontist remains fully involved in patient diagnosis, appliance design, and treatment planning and monitoring.

More recently, Align Technologies began offering transparent, removable aligning devices as a new treatment modality in orthodontics. In this system, an impression model of the dentition of the patient is obtained by the orthodontist and shipped to a remote appliance manufacturing center, where it is scanned with a CT scanner. A computer model of the dentition in a target situation is generated at the appliance manufacturing center and made available for viewing to the orthodontist over the Internet. The orthodontist indicates changes they wish to make to individual tooth positions. Later, another virtual model is provided over the Internet and the orthodontist reviews the revised model, and indicates any further changes. After several such iterations, the target situation is agreed upon. A series of removable aligning devices or shells are manufactured and delivered to the orthodontist. The shells, in theory, will move the patient's teeth to the desired or target position.

U.S. Pat. No. 6,699,037 Align Technologies describes an improved methods and systems for repositioning teeth from an initial tooth arrangement to a final tooth arrangement. Repositioning is accomplished with a system comprising a series of appliances configured to receive the teeth in a cavity and incrementally reposition individual teeth in a series of at least three successive steps, usually including at least four successive steps, often including at least ten steps, sometimes including at least twenty-five steps, and occasionally including forty or more steps. Most often, the methods and systems will reposition teeth in from ten to twenty-five successive steps, although complex cases involving many of the patient's teeth may take forty or more steps. The successive use of a number of such appliances permits each appliance to be configured to move individual teeth in small increments, typically less than 2 mm, preferably less than 1 mm, and more preferably less than 0.5 mm. These limits refer to the maximum linear translation of any point on a tooth as a result of using a single appliance. The movements provided by successive appliances, of course, will usually not be the same for any particular tooth. Thus, one point on a tooth may be moved by a particular distance as a result of the use of one appliance and thereafter moved by a different distance and/or in a different direction by a later appliance.

The individual appliances will preferably include a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the patient, certain of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step.

The fabrication of aligners by Align Technologies utilizes stereo lithography process as disclosed in U.S. Pat. Nos. 6,471,511 and 6,682,346. Several drawbacks exist however with the stereo lithography process. The materials used by stereo lithography process may be toxic and harmful to human health. Stereo lithography process builds the aligner mold layer by layer causing the resulting aligners to have a stairmaster like spacing between the layers and such spacing has a tendency house germs and bacteria while it is worn by a patient. Furthermore, stereo lithography process used by Align Technology also requires a different aligner mold at each stage of the treatment, which produces waste and is environmental unfriendly.

The practice of orthodontics and other dental treatments including preparation of a denture can benefit from a physical dental arch model that is representative of the dentition and the alveolar ridge of a patient to be orthodontically treated. The physical dental arch model, also referred as a physical dental arch model, is often prepared based on an impression model. The physical dental arch model is generally prepared by cutting and arranging individual teeth on the alveolar ridge of the impression model. With this physical dental arch model so prepared, not only is a final goal for the dental treatment made clear, but also the occlusal condition between the maxillary and the mandibular dentitions can be ascertained specifically.

Also, the patient when the physical dental arch model is presented can visually ascertain the possible final result of orthodontic treatment he or she will receive and, therefore, the physical dental arch model is a convenient tool in terms of psychological aspects of the patient.

Making a model for a whole or a large portion of an arch is more difficult than making one tooth abutment for implant purposes. Single teeth do not have concavities and complexities as in the inter-proximal areas of teeth in an arch. Some prior art making the physical dental arch model is carried out manually, involving not only a substantial amount of labor required, but also a substantial amount of time. It is also difficult to machine an accurate arch model because of the various complex shapes and the complex features such as inter-proximal areas, wedges between teeth, among others, in an arch.

### SUMMARY OF THE INVENTION

In one aspect, the present invention relates to a method for producing a base configured to receive physical tooth models, comprising:

acquiring the coordinates of the physical tooth models in the physical dental arch model using an optical location device;

determining the configurations of first features affixed to the physical tooth models; and

determining the locations of second features in the base in accordance with the coordinates of the physical tooth models in the physical dental arch model and the configurations of the first features, wherein the second features are configured to receive the first features affixed to the physical tooth models.

In another aspect, the present invention relates to a method for acquiring the coordinates of a patient's dental arch, comprising:

obtaining an impression of the patient's arch;

touching a point on the surface of the impression by a stylus connected to a location device, wherein the location device includes a plurality of rigidly connected marking objects;

capturing an image of the plurality of rigidly connected marking objects;

determining the coordinates of marking objects; and

using the coordinates of marking objects to calculate the position of the stylus to obtain the coordinates of the point on the surface of the impression.

In yet another aspect, the present invention relates to a physical dental arch model, comprising:

one or two physical tooth models each comprising a tooth portion and two or more first features affixed to the bottom of the tooth portion; and

a base comprising a plurality of second features configured to receive first features affixed to the physical tooth models, wherein the locations of the second features determined by the coordinates acquired from the impression of a patient arch using an optical location device.

Embodiments may include one or more of the following advantages. An advantage of the present invention is that a physical base can be produced with accurate socket positions for receiving physical tooth models affixed with pins. The socket positions are accurately determined by coordinates acquired by a location device from the impression of a patient's arch.

Another advantage of the present invention is that the same physical tooth models can be used to form different tooth arch models having different teeth configurations. The tooth models can be reused as tooth positions are changed during a treatment process. Much of the cost of making multiple tooth arch models in orthodontic treatment is therefore eliminated. The physical tooth models include features to allow them to be attached, plugged or locked to a base. The physical tooth models can be pre-fabricated having standard registration and attaching features for assembling. The physical tooth models can be automatically assembled onto a base by a robotic arm under computer control.

The physical dental arch model obtained by the disclosed system and methods can be used for various dental applications such as dental crown, dental bridge, aligner fabrication, biometrics, and teeth whitening. The arch model can be assembled from segmented manufacturable components that can be individually manufactured by automated, precise numerical manufacturing techniques.

Another advantage of the present invention is that the same base can support different tooth arch models having different teeth configurations. The base can include more than one set of receiving features that can receive tooth models at different positions. The reusable base further reduces cost in the dental treatment of teeth alignment.

Yet another advantageous feature of the disclosed system and methods is that the physical tooth models in the physical dental arch model can be easily separated, repaired or replaced, and reassembled after the assembly without the replacement of the whole arch model.

Simplicity is another advantage of the disclosed system and methods. The manufacturable components can be attached to a base. The assembled physical dental arch model specifically corresponds to the patient's arch. There is no need for complex and costly mechanisms such as micro-actuators for adjusting multiple degrees of freedom for each tooth model. The described methods and system is simple to make and easy to use.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 is a flow chart for producing a physical dental arch model in accordance with the present invention.

FIG. 2 illustrates a tooth model and a base respectively comprising complimentary features for assembling the tooth model with the base.

FIG. 3 illustrates fixing a stud to a tooth model comprising a female socket to produce a tooth model having a protruded stud.

FIG. 4 illustrate a tooth model comprising two pins that allow the tooth model to be plugged into two corresponding holes in a base.

FIG. 5 illustrate a tooth model comprising a protruded pin that allows the tooth model to be plugged into a hole in a base.

FIG. 6 illustrates cone shaped studs protruded out of the bottom of a tooth model.

FIG. 7 illustrates exemplified shapes for the studs at the bottom of a tooth model.

FIG. 8A illustrates an example of a base comprising a plurality of female sockets for receiving a plurality of tooth models for forming a physical dental arch model.

FIG. 8B illustrates another example of a base comprising a plurality of female sockets for receiving a plurality of tooth models for forming a physical dental arch model.

FIG. 9 illustrates a tooth model that can be assembled to the base in FIGS. 8A and 8B.

FIG. 10 illustrates an example of an optical location device for acquiring the coordinates of the physical tooth models.

### DESCRIPTION OF INVENTION

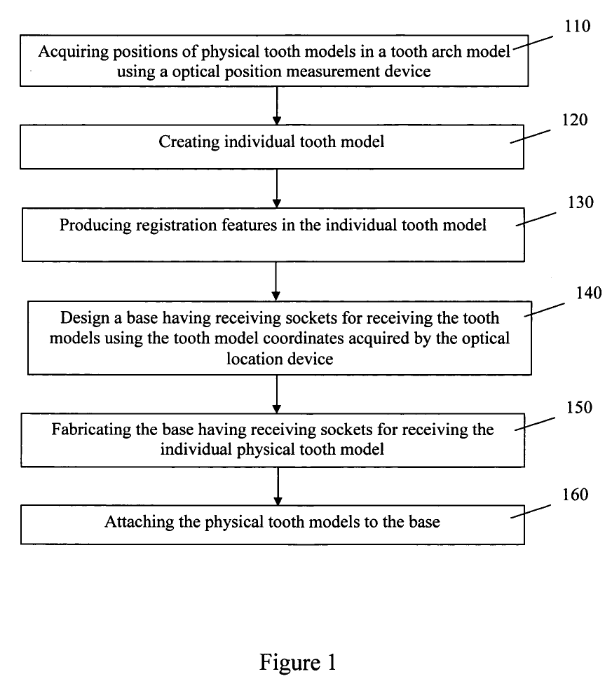

Major operations in producing a physical dental arch model are illustrated in FIG. 1. The process generally includes the following steps. The positions of physical tooth models in a tooth arch model are acquiring using an optical location device in step 110. First individual tooth model is created in step 120. An individual tooth model is a physical model that can be part of a physical tooth arch model, which can be used in various dental applications. Registration features are next added in step 130 to the individual tooth model to allow them to be attached to each other or a base. A base is designed having receiving sockets for receiving the tooth models using the tooth model positions acquired optical location device in step 140. A base is fabricated in step 150. the base includes receiving sockets for receiving the individual physical tooth model. The tooth models are finally attached to the base at the predetermined positions using the pre-designed features in step 160.

Details of process in FIG. 1 are now described. In accordance with the present invention, the positions of physical tooth models in a tooth arch model are first acquired using an optical location device (step 110). An impression of a patient's arch is first made using a pre-designed container. The impression is fixed in the container using an epoxy.

The first feature location and orientation are determined by measuring the positions of the surfaces in the impression of the patient's arch using an optical location system 1000. An impression 1010 is first obtained from a patient's arch and held in a container 1020. A location device 1030 comprises three marking objects 1040, 1050, and 1060 that are connected by “T” shaped linking arms 1070. The marking objects 1040, 1050, 1060 can take the shape of spheres, boxes, or triangles. In one embodiment, the marking objects can be balls in different colors such as red, green and black color. Below the lower marking object 1040 is a stylus 1080 that can come into contact with the surface of the impression 1020. The six degrees of freedom of the location device 1030 can be obtained by various techniques.

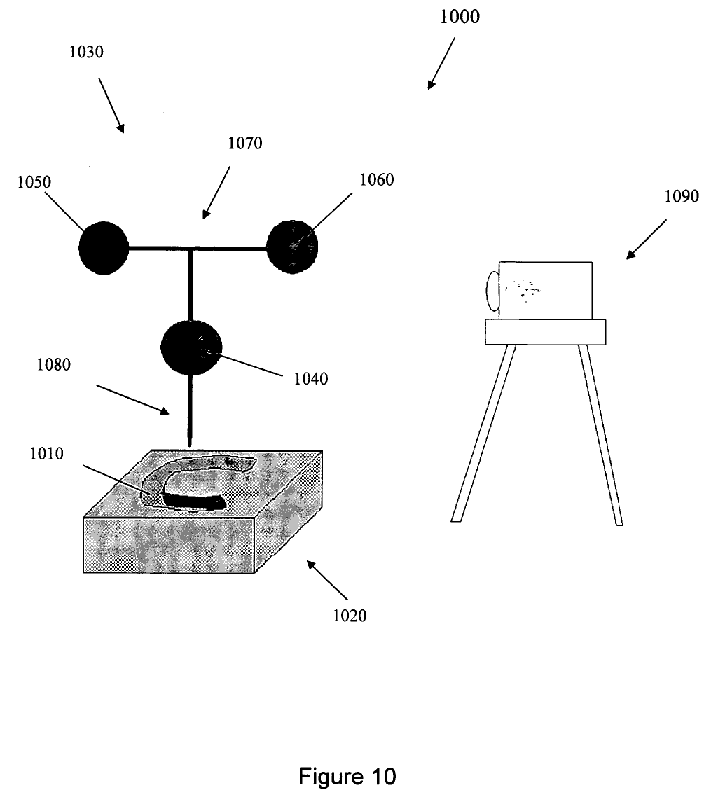

In one embodiment, as shown in FIG. 10, the tip of the stylus 1080 is brought in contact with a point on the impression surface device. A camera system 1090 captures the images of the location device 1030. The camera system 1090 may include a plurality of cameras that point at different viewing angles at the location device 1030. The positions and orientation of the “T” shaped linking arms 1070 and the stylus 1080 are obtained by image analysis. The marking objects 1040, 1050, 1060 can be of different colors and spherical shapes for ease of pattern recognition. The center of each marking object 1040, 1050, 1060 is determined. The coordinates of the marking objects 1040, 1050, 1060 are obtained using triangulation technique. The “T” shape of the linking arm 1070 is reconstructed. The distances are derived by pattern recognition. The tip of the stylus 1080 is then moved to a different point on the surface of the impression 1020. Images of the location device 1030 are again captured. The steps are repeated until the surfaces of the teeth on the impression 1020 are mapped out. The first feature location and orientations of the surface are calculated and logged.

In another embodiment, the image analysis and processing can include the search for a specific object in a binary image including objects of various shapes, positions, orientations, etc., which is often referred to as “chamfer matching.” Chamfer matching uses an edge matching technique in which the edge points of one image are transformed by a set of parametric transformation equations to edge points of a similar image that is slightly different. For example, spherically shaped marking objects can be fit to a pre-designed circles in the image. The positions of the marking objects 1040, 1050, 1060 are obtained exactly using chamfer matching, which can be used to determine the position of the tip of the stylus 1080 on the surface of the dental impression 1010.

The captured images often contain noise, which need to be properly removed for the accuracy of the coordinate calculations. On the other hand, the noise removal should also not produce artificial information, which may also affect the accuracy of the calculations. The noises can be removed by several techniques such as transparent pen.

In another embodiment, the positions of points on the surfaces of the patient arch impression are captured by an optical capture system. An optical capture system includes digital cameras to track the positions of the reflective markers attached to the marking objects. An Infra-red (IR) LED's is placed near a camera lens along with IR pass filters over the camera lens. The invention system can include seven video cameras connected to a computer. Each marking object can have seven or more reflective markers attached. Infra-red (IR) LED's can be mounted around the camera lens along with IR pass filters placed over the lens. The light emitted from the LED's is reflected by the markers and then captured by the cameras. The centers of the marker images are matched from the various camera views using triangulation to compute their frame-to-frame positions in 3D space. A skeleton of the marker positions can be captured. The captured skeleton moves around the object's skeleton, which moves the mesh that makes up the skin of the character. This results in animation of the moving object. The calculated coordinates are verified by matching image analysis from the images captured by different cameras.

In another embodiment, the marking objects are marked by sparkles that reflect lights in visible wavelengths. The sparkle serves as a reference point from the successive image to assists tracking the movement of the marking objects. The sparkles on successive images help to determine the amount of movement.

In yet another embodiment, a magnetic motion capture system is used to track the locations of the marking objects. Magnets and magnetic sensors are first attached to each of the marking objects 1040, 1050, 1060. The magnets and the sensors are connected with cables to a magnetic motion tracking system. The sensors detects low-frequency magnetic field generated by transmitting magnetic fields by the magnets. The correlations between the magnets and detected signals can be used to calculate the locations of the transmitting source, that is, the magnets. The positional and rotational information about the balls can be obtained, stored, and displayed by a computer system. The magnetic motion tracking systems can include 6 or more sensors per object to record body joint motion. The sensors report position and rotational information. An Inverse kinematics (IK) algorithm is used to solve the angles for the various body joints, and compensate for the offset between the sensors and the actual joint's center of rotation. In addition to magnetic sensors, other sensors such as optical or location sensitive sensors such as GPS sensors can be used.

After the readings for each surface position in the dental impression, the coordinate data can be stored. The saved data will also be load-able in the software for fine tuning and visualization. A digital dental arch model usually includes a plurality of digital tooth models. The digital dental model can be developed based on the first feature location and orientation or alternatively the coordinates of the physical tooth models acquired by the optical location device 1000. The exported data can be used to control CNC based drilling and milling.

The number of points defining the curves and number of curves depends on the desired resolution in the model. Surfacing functions offered by the design application are used to create and blend the model surfaces. The model may be shaded or rendered, defined as a solid or animated depending on the designer's intentions. The teeth are labeled so the order of the physical tooth models are can properly be defined for the physical dental arch model. All the readings acquired by the stylus can be rendered in real time to allow the user to visualize the digital tooth models. The coordinate axes and points can be rendered in the software using different colored cylinders/spheres etc. so as to distinguish the different meanings of values.

Individual tooth model can be obtained in step 120 in a number of different methods. The tooth model can be created by casting. A negative impression is first made from a patient's arch using for example PVS. A positive of the patient's arch is next made by pouring a casting material into the negative impression. After the material is dried, the mould is then taken out with the help of the impression knife. A positive of the arch is thus obtained.

In an alternative approach, the negative impression of the patient's tooth arch is placed in a specially designed container. A casting material is then poured into the container over the impression to create a model. A lid is subsequently placed over the container. The container is opened and the mould can be removed after the specified time.

Examples of casting materials include auto polymerizing acrylic resin, thermoplastic resin, light-polymerized acrylic resins, polymerizing silicone, polyether, plaster, epoxies, or a mixture of materials. The casting material is selected based on the uses of the cast. The material should be easy for cutting to obtain individual tooth model. Additionally, the material needs to be strong enough for the tooth model to take the pressure in pressure form for producing a dental aligner. Details of making a dental aligner are disclosed in commonly assigned and above referenced US patent application titled “Method and apparatus for manufacturing and constructing a dental aligner” by Huafeng Wen, filed Nov. 1, 2004, the content of which is incorporated herein by reference.

Features that can allow tooth models to be attached to a base (step 140) can be added to the casting material in the casting process. Registration points or pins can be added to each tooth before the casting material is dried. Optionally, universal joints can be inserted at the top of the casting chamber using specially designed lids, which would hang the universal joints directly into the casting area for each tooth.

Still in step 120, individual tooth models are next cut from the arch positive. One requirement for cutting is to obtain individual teeth in such a manner that they can be joined again to form a tooth arch. The separation of individual teeth from the mould can be achieved using a number of different cutting methods including laser cutting and mechanical sawing.

Separating the positive mould of the arch into tooth models may result in the loss of the relative 3D coordinates of the individual tooth models in an arch. Several methods are provided in step 140 for finding relative position of the tooth models. In one embodiment, unique registration features are added to each pair of tooth models before the positive arch mould is separated. The separated tooth models can be assembled to form a physical dental arch model by matching tooth models having the same unique registration marks.

The positive arch mould can also be digitized by a three-dimensional scanning using a technique such as laser scanning, optical scanning, destructive scanning, CT scanning and Sound Wave Scanning. A physical digital dental arch model is therefore obtained. The physical digital dental arch model is subsequently smoothened and segmented. Each segment can be physically fabricated by CNC based manufacturing to obtain individual tooth models. The physical digital dental arch model tracks and stores the positions of the individual tooth models. Unique registration marks can be added to the digital tooth models that can be made into a physical feature in CNC base manufacturing.

Examples of CNC based manufacturing include CNC based milling, Stereolithography, Laminated Object Manufacturing, Selective Laser Sintering, Fused Deposition Modeling, Solid Ground Curing, and 3D ink jet printing. Details of fabricating tooth models are disclosed in commonly assigned and above referenced US patent application titled “Method and apparatus for manufacturing and constructing a physical dental arch mode” by Huafeng Wen, filed Nov. 1, 2004, the content of which is incorporated herein by reference.

In another embodiment, the separated tooth models are assembled by geometry matching. The intact positive arch impression is first scanned to obtain a 3D physical digital dental arch model. Individual teeth are then scanned to obtain digital tooth models for individual teeth. The digital tooth models can be matched using rigid body transformations to match a physical digital dental arch model. Due to complex shape of the arch, inter-proximal areas, root of the teeth and gingival areas may be ignored in the geometry match. High precision is required for matching features such as cusps, points, crevasses, the front faces and back faces of the teeth. Each tooth is sequentially matched to result in rigid body transformations corresponding to the tooth positions that can reconstruct an arch.

In another embodiment, the separated tooth models are assembled and registered with the assistance of a 3D point picking devices. The first feature locations and orientations or alternatively the coordinates of the tooth models are picked up by 3D point picking devices such as stylus or Microscribe devices before separation. Unique registration marks can be added on each tooth model in an arch before separation. The tooth models and the registration marks can be labeled by unique IDs. The tooth arch can later be assembled by identifying tooth models having the same registration marks as were picked from the Jaw. 3D point picking devices can be used to pick the same points again for each tooth model to confirm the first feature location and orientation or the tooth coordinates.

The base is designed in step 140 to receive the tooth models. The base and tooth models include complimentary features to allow them to be assembled together. The tooth model has a protruding structure attached to it. The features at the base and tooth models can also include a registration slot, a notch, a protrusion, a hole, an interlocking mechanism, and a jig. The protruding structure can be obtained during the casting process or be created after casting by using a CNC machine on each tooth.

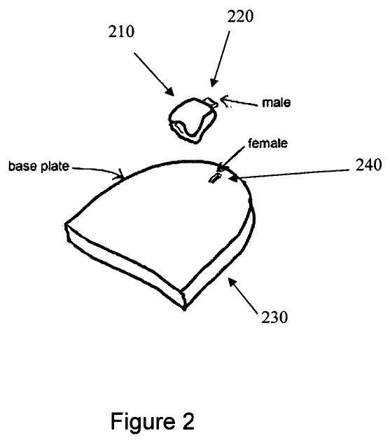

Before casting the arch from the impression, the base plate is taken through a CNC process to create the female structures for each individual tooth (step 150). Then the base is placed over the casting container in which the impression is already present and the container is filled with epoxy. The epoxy gets filled up in the female structures and the resulting mould has the male studs present with each tooth model that can be separated afterwards. FIG. 2 shows a tooth model 210 with male stud 220 after mould separation. The base 230 comprises a female feature 240 that can receive the male stud 220 when the tooth model 210 is assembled to the base 230.

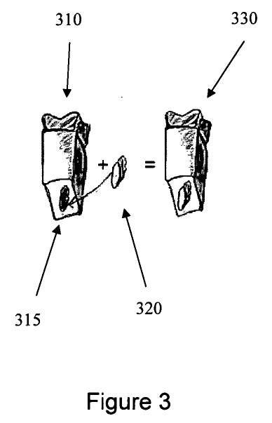

Alternatively, as shown in FIG. 3, a tooth model 310 includes a female socket 315 that can be drilled by CNC based machining after casting and separation. A male stud 320 that fits the female socket 315 can be attached to the tooth model 310 by for example, screwing, glue application, etc. The resulted tooth model 330 includes male stud 310 that allows it to be attached to the base.

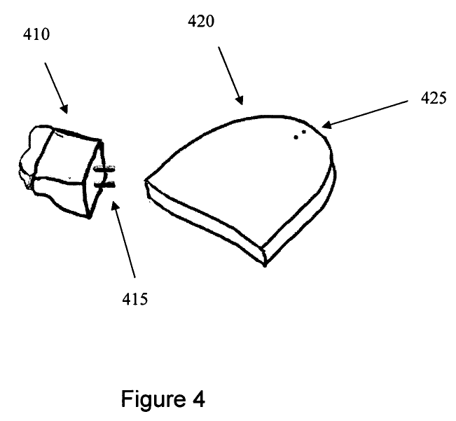

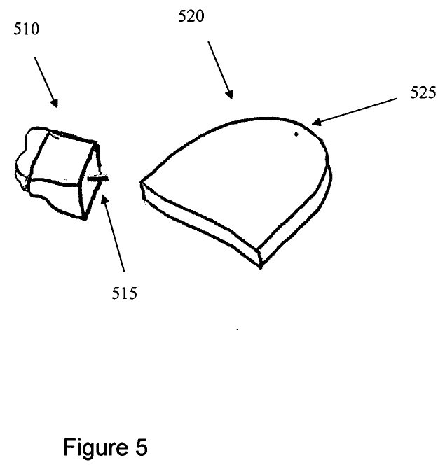

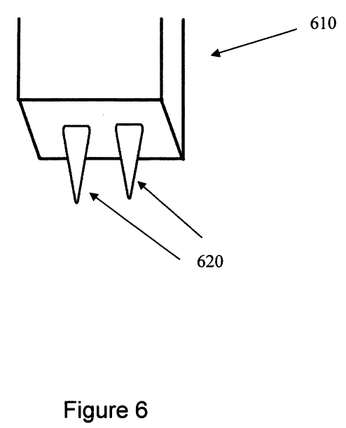

Male protrusion features over the tooth model can exist in a number of arrangements. FIG. 4 shows a tooth model 410 having two pins 415 sticking out and a base 420 having registration slots 425 adapted to receive the two pins 415 to allow the tooth model 410 to be attached to the base 420. FIG. 5 shows a tooth model 510 having one pins 515 protruding out and a base 520 having a hole 525 adapted to receive the pin 515 to allow the tooth model 510 to be attached to the base 520. In general, the tooth model can include two or more pins wherein the base will have complementary number of holes at the corresponding locations for each tooth model. The tooth model 610 can also include cone shaped studs 620 as shown in FIG. 6. The studs can also take a combination of configurations described above.

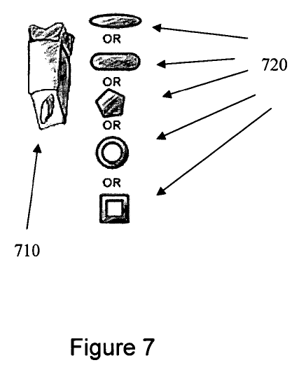

As shown FIG. 7, the studs protruding our of the tooth model 710 can take different shapes 720 such as oval, rectangle, square, triangle, circle, semi-circle, each of which correspond to slots on the base having identical shapes that can be drilled using the CNC based machining. The asymmetrically shaped studs can help to define a unique orientation for the tooth model on the base.

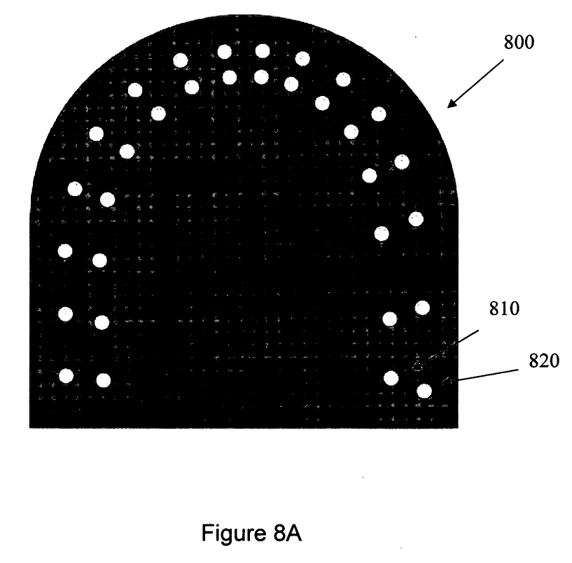

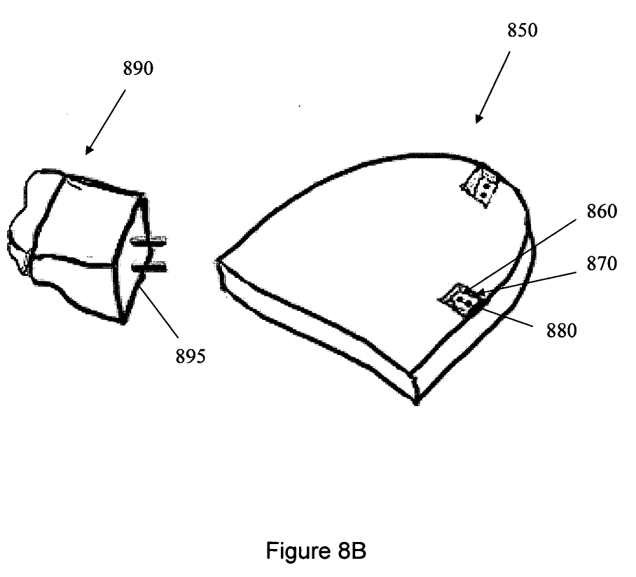

FIG. 8A shows a base 800 having a plurality of sockets 810 and 820 for receiving the studs of a plurality of tooth models. The positions of the sockets 810,820 are determined by either her initial teeth positions in a patient's arch or the teeth positions during the orthodontic treatment process. The base 800 can be in the form of a plate as shown in FIG. 8, comprising a plurality of pairs of sockets 810,820. Each pair of sockets 810,820 is adapted to receive two pins associated with a physical tooth model. Each pair of sockets includes a socket 810 on the inside of the tooth arch model and a socket 820 on the outside of the tooth arch model.

Another of a base 850 is shown in FIG. 8B. A plurality of pairs of female sockets 860, 870 are provided in the base 850. Each pair of the sockets 860, 870 is formed in a surface 880 and is adapted to receive a physical tooth model 890. The bottom portion of the physical tooth model 890 includes a surface 895. The surface 895 comes to contact with the surface 880 when the physical tooth model 890 is inserted into the base 850, which assures the stability of the physical tooth model 890 over the base 850.

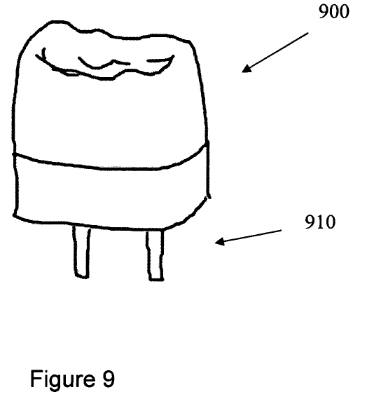

A tooth model 900 compatible with the base 800 is shown in FIG. 9. The tooth model 900 includes two pins 910 connected to its bottom portion. The two pins 910 can be plugged into a pair of sockets 810 and 820 on the base 800. Thus each pair of sockets 810 and 820 uniquely defines the positions of a tooth model. The orientation of the tooth model is also uniquely defined if the two pins are labeled as inside and outside, or the sockets and the pins are made asymmetric inside and outside. In general, each tooth model may include correspond to one or a plurality of studs that are to be plugged into the corresponding number of sockets. The male studs and the sockets may also take different shapes as described above.

A tooth arch model is obtained after the tooth models are assembled to the base 800 (step 160). The base 800 can comprise a plurality of configurations in the female sockets 810. Each of the configurations is adapted to receive the same physical tooth models to form a different arrangement of at least a portion of a tooth arch model.

The base 800 can be fabricated by a system that includes a computer device adapted to store digital tooth models representing the physical tooth models. As described above, the digital tooth model can be obtained by various scanning techniques. A computer processor can then generate a digital base model compatible with the digital tooth models. An apparatus fabricates the base using CNC based manufacturing in accordance with the digital base model. The base fabricated is adapted to receive the physical tooth models.

The physical tooth models can be labeled by a predetermined sequence that define the positions of the physical tooth models on the base 800. The labels can include a barcode, a printed symbol, hand-written symbol, a Radio Frequency Identification (RFID). The female sockets 810 can also be labeled by the parallel sequence for the physical tooth models.

In one embodiment, tooth models can be separated and repaired after the base. The tooth models can be removed, repaired or replaced, and re-assembled without the replacement of the whole arch model.

Common materials for the tooth models include polymers, urethane, epoxy, plastics, plaster, stone, clay, acrylic, metals, wood, paper, ceramics, and porcelain. The base can comprise a material such as polymers, urethane, epoxy, plastics, plaster, stone, clay, acrylic, metals, wood, paper, ceramics, porcelain, glass, and concrete.

The arch model can be used in different dental applications such as dental crown, dental bridge, aligner fabrication, biometrics, and teeth whitening. For aligner fabrication, for example, each stage of the teeth treatment may correspond a unique physical dental arch model. Aligners can be fabricated using different physical dental arch models one at a time as the teeth movement progresses during the treatment. At each stage of the treatment, the desirable teeth positions for the next stage are calculated. A physical dental arch model having modified teeth positions is fabricated using the process described above. A new aligner is then made using the new physical dental arch model.

The system can also be used in conjunction with a casting chamber by receiving a negative impression of a patient's tooth in a casting chamber; pouring a casting material over the negative impression of the patient's tooth; solidifying the casting material wherein the casting material is attached to the lid of the casting chamber; and cutting a tooth portion off the solidified casting material to produce a reference base portion of the casting material attached to the lid of the casting chamber, wherein the reference base is configured to mold the physical tooth model. In another aspect, the method for producing a physical tooth model can include receiving a negative impression of a patient's tooth in a casting chamber; pouring a casting material over the negative impression of the patient's tooth; solidifying the casting material wherein the casting material is attached to the lid of the casting chamber; cutting a tooth portion off the solidified casting material to produce a reference base attached to the lid of the casting chamber, and producing first features in the reference base to assist the molding of the physical tooth model having second features complimentary to the first features using the reference base. The casting system for producing a physical tooth model can include a casting chamber configured to hold a negative impression of a patient's tooth and to receive casting material that can subsequently solidify in the casting chamber; a chamber lid configured to hold the solidified casting material and to produce a reference base by cutting off the tooth portion, wherein the reference base is adapted to mold the physical tooth model. More details on the casting chamber are disclosed in application Ser. No. ______ entitled “PRODUCING A PHYSICAL TOOTHMODEL COMPATIBLE WITH A PHYSICAL DENTAL ARCH MODEL”, the content of which is incorporated herewith.

In accordance with the present invention, each base is specific to an arch configuration. There is no need for complex and costly mechanisms such as micro-actuators for adjusting multiple degrees of freedom for each tooth model. The described methods and system is simple to make and easy to use.

The described methods and system are also economical. Different stages of the arch model can share the same tooth models. The positions for the tooth models at each stage of the orthodontic treatment can be modeled using orthodontic treatment software. Each stage of the arch model may use a separate base. Or alternatively, one base can be used in a plurality of stages of the arch models. The base may include a plurality of sets of receptive positions for the tooth models. Each set corresponds to one treatment stage. The tooth models can be reused through the treatment process. Much of the cost of making multiple tooth arch models in orthodontic treatment is therefore eliminated.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method for producing a base configured to receive physical tooth models, comprising:
acquiring coordinates of the physical tooth models in the physical dental arch model using an optical location device;
determining configurations of first features affixed to the physical tooth models; and
determining locations of second features in the base in accordance with the coordinates of the physical tooth models in the physical dental arch model and the configurations of the first features,
configuring one or more sockets to receive the first features affixed to the physical tooth models.

2. The method of claim 1, further comprising fabricating a physical base using Computer Numerical Control (CNC), wherein the base comprises the second features at the locations in accordance with the coordinates of the physical tooth models in the physical dental arch model and the configurations of the first features affixed to the physical tooth models.

3. The method of claim 1, further comprising acquiring the positions and orientations of the physical tooth models from an impression of a patient's dental arch using an optical location device.

4. The method of claim 1, wherein the optical location device comprises
a stylus configured to touch points on the surface of the impression;
a linking arm connected to the stylus, and
an imaging system to determine the coordinates of the points touched by the stylus.

5. The method of claim 1, wherein determining the configurations of the first features affixed to the physical tooth models includes acquiring the coordinates of the first features affixed to physical tooth models using an optical location device

6. The method of claim 1, wherein determining the configurations of the first features affixed to the physical tooth models includes acquiring the coordinates of the first features affixed to physical tooth models using a digital dental model representing the physical tooth models.

7. The method of claim 1, further comprising fabricating a physical base comprising the second features at the locations in accordance with the coordinates of the physical tooth models in the physical dental arch model and the configurations of the first features affixed to the physical tooth models.

8. The method of claim 1, further comprising
developing a digital dental arch model comprising a plurality of digital tooth models in response to the coordinates of the physical tooth models acquired by the optical location device and the configurations of the first features affixed to the physical tooth models.

9. The method of claim 1, further comprising
fabricating the physical tooth models affixed with the first features having the configurations in response to the digital dental arch model.

10. The method of claim 1, further comprising
inserting the first features affixed to the physical tooth models into the corresponding second features in the base to form a physical dental arch model.

11. The method of claim 1, wherein the first features comprise one or more of a pin, a registration slot, a socket, a notch, a protrusion, a hole, an interlocking mechanism, a jig, a pluggable feature and an attachable feature.

12. A method for acquiring the coordinates of a patient's dental arch, comprising:
receiving an impression of the patient's arch;
touching at least a point on the surface of the impression with a stylus connected to a location device, wherein the location device includes a plurality of rigidly connected marking objects;
capturing an image of the plurality of rigidly connected marking objects;
determining the coordinates of marking objects; and
using the coordinates of marking objects to calculate the position of the stylus to obtain the coordinates of the point on the surface of the impression.

13. The method of claim 12, wherein determining the coordinates of marking objects comprises
recognizing patterns of the marking objects; and
calculating coordinates of centers of the marking objects.

14. The method of claim 12, further comprising:
capturing a plurality of images of the rigidly connected marking objects from different directions using a plurality of cameras; and
determining the coordinates of marking objects by correlating the plurality of images.

15. The method of claim 12, further comprising
attaching reflective markers to the marking objects;
capturing an image of the reflective markers; and
determining the coordinates of marking objects using the image of the reflective markers.

16. The method of claim 12, further comprising
attaching infrared reflective markers to the marking objects;
irradiating infrared light on the infrared reflective markers;
capturing an infrared image of the infrared reflective markers; and
determining the coordinates of marking objects using the image of the infrared reflective markers.

17. The method of claim 12, further comprising
attaching magnetic markers and magnetic sensors to the marking objects;
capturing an image of the magnetic markers; and
determining the coordinates of marking objects using the image of the magnetic markers.

18. A physical dental arch model, comprising:
one or two physical tooth models each comprising a tooth portion and two or more first features affixed to the bottom of the tooth portion; and
a base comprising a plurality of second features configured to receive first features affixed to the physical tooth models, wherein the locations of the second features determined by the coordinates acquired from the impression of a patient arch using an optical location device.

19. The physical dental arch model of claim 18, wherein the first features comprise one or more of a pin, a registration slot, a socket, a notch, a protrusion, a hole, an interlocking mechanism, a jig, and a pluggable or attachable feature.

20. The physical dental arch model of claim 18, wherein the base comprises a plurality of pairs of sockets, wherein each pair of sockets are configured to receive a physical tooth model affixed with two pins.
